(19) United States
(12) Patent Application Publication
(10) Pub. No.: US 2026/0321832 A1
(43) Pub. Date: Oct. 15, 2026

(54) SEAL ELEMENT FOR A PRISMATIC BATTERY CELL LID ASSEMBLY AND LID ASSEMBLY HAVING SUCH SEAL ELEMENT

(71) Applicant: FREUDENBERG SEALING TECHNOLOGIES S.A.S. DI EXTERNA ITALIA S.R.L.U., PINEROLO (TO) (IT)

(72) Inventors: Alessandro BOI, PINEROLO (TO) (IT); David KUHNE, WEHR (DE); Stefan SCHNEIDER, OESTRINGEN (DE); Ingo STEPHAN, RIMBACH (DE); Marco BOSCOLO, PINEROLO (TO) (IT)

(73) Assignee: FREUDENBERG SEALING TECHNOLOGIES S.A.S. DI EXTERNA ITALIA S.R.L.U., PINEROLO (TO) (IT)

(21) Appl. No.: 19/479,149

(22) PCT Filed: Apr. 27, 2023
(86) PCT No.: PCT/IB2023/054364

§ 371 Date: Oct. 27, 2025

(51) Int. Cl. H01M 50/188; H01M 50/103; H01M 50/184

(52) U.S. Cl. CPC H01M 50/188; H01M 50/103; H01M 50/184

(57) ABSTRACT

There is described a seal element for a lid assembly apt to close in a fluid-tight manner an inner compartment of a prismatic battery cell, the seal element is configured to be interposed between a current collector of the lid assembly and a base plate of the lid assembly for electrically insulating the current collector and the lid assembly from one another and for fluid-tightly sealing the inner compartment, the seal element has a central axis, presents a substantially L-shaped semi-profile with respect to the central axis, and comprises: an axial collar extending annularly about the central axis and configured to electrically insulate the current collector from the base plate; and a radial sealing portion protruding from the collar in a cantilevered manner and configured to fluid-tightly seal the inner compartment; the sealing portion includes a main body and a bulge or bump extending from the main body and defining a free end of the sealing portion, the bulge or bump has an axial size greater than the axial size of the main body.

### TECHNICAL FIELD

The present invention relates to a seal element for a lid assembly of a prismatic battery cell, in particular a lid assembly for closing and sealing in a fluid-tight manner an inner compartment of a prismatic battery cell housing electrodes and electrolytic material.

The present invention also relates to a lid assembly for a prismatic battery cell having such seal element.

### BACKGROUND ART battery cells are known, which are used as electrical energy accumulators.

In particular, so-called primary batteries are known, which cannot be easily recharged and are therefore destined to single-use, and so-called secondary batteries are known, which can be repeatedly charged after each cycle of usage.

Single-cell batteries of the secondary type are known which are used for various portable small-sized electronic devices, such as cellular phones, watches, smartwatches, smartbands, etc.

Also batteries which include a plurality of cells connected in series or in parallel are known, for example as used in the automotive industry.

The present invention will refer to a battery cell for the use in a battery of a hybrid or full electric vehicle, without however losing generality.

Secondary battery cells can be manufactured as various types, such as cylindrical or prismatic cells.

The present invention will refer to prismatic battery cells, without however losing generality.

A prismatic battery cell typically comprises a hollow prismatic casing, for example in the shape of a parallelepiped and usually made of metallic material, and two electrodes (cathode and anode) housed within the casing, which then defines an inner compartment of the cell.

The compartment also houses a separator material electrically interposed between the two electrodes.

Within the compartment, the electrodes and the separator are immersed in an electrolytic solution, usually liquid or gelatinous.

The battery cell also comprises at least one lid assembly which is coupled to the casing for closing the compartment.

More specifically, the casing usually has at least one (rectangular) opening, normally located on its top, through which the electrodes, separator and electrolytic solution are inserted into the compartment. The lid assembly is coupled to the casing for closing such opening.

The lid assembly typically comprises:
a base plate, typically metallic, arranged to match and engage the opening of the casing for the closing thereof;
a current collector for each electrode, which is electrically connected to the relative electrode and is configured to collect the electric energy form such electrode and feed it from the inner compartment towards the outside environment; and
a terminal for each electrode, which is electrically connected with the respective collector for receiving the electric energy therefrom, and which is configured to receive a connector of a consumer device which has to be powered by the battery cell.

The lid assembly further comprises a seal element for each current collector, which is made of resilient and electrically insulating material and which serves the twofold function of: electrically insulating the collector from the base plate; fluid-tightly sealing the inner compartment of the casing from the outside environment.

To this end, the seal element is mechanically interposed between the respective collector and the base plate, so that the collector and the base plate are not arranged in direct contact with one another, but still being mutually coupled only via the seal element itself.

In some configurations, the casing has two openings, one for each electrode, for example two lateral openings. In this case, the battery has two lid assemblies, one for each electrode and each having its respective base plate, a single terminal, a single collector, and a single seal element.

Generally, the seal element is defined by a simple o-ring.

According to some known configurations, the seal element is L-shaped.

In light of the above, the lid assembly seals the inner compartment in a fluid-tight manner.

Accordingly, the seal element (which defines a gasket of the lid assembly) is configured to prevent a leakage of electrolytic solution outside the inner compartment and/or an undesired entering of external impurities (dust, sand) within the inner compartment.

It is also known to pressurize the inner compartment in order to ensure optimal operation of the battery cell.

Furthermore, it is well known that during operation, electrolytic gases generate, which permeate the inner compartment and define a pressure build-up. Such pressure build-up causes a stress action on the seal element.

The Applicant has observed how the known seal elements for lid assemblies of the aforementioned type are still open to further improvements, in particular as per the fluid-thigh sealing effectiveness, as per the electric insulation effectiveness, and as per the lifespan of the seal element itself.

### DISCLOSURE OF INVENTION

It is therefore an object of the present invention to provide a seal element and a lid assembly for prismatic battery cell comprising such seal element which are designed to meet at least one of the above-mentioned needs in a straightforward and low-cost manner.

This object is achieved by a seal element and a lid assembly as claimed in the appended claims.

### BRIEF DESCRIPTION OF THE DRAWINGS

Non-limiting embodiments of the present invention will be described by way of example with reference to the accompanying drawings, in which:

FIG. 1 is an exploded view, with parts removed for clarity, of a lid assembly for a prismatic battery cell, comprising a seal element according to the present invention;

FIG. 2 is a larger scale side view of the lid assembly of FIG. 1 in its assembled condition;

FIG. 3 is a partially sectioned, larger scale, perspective view of the lid assembly of FIG. 1 in its assembled configuration, showing in particular the region where the seal element is arranged;

FIG. 4 is a sectioned view of the seal element according to the invention; and

FIG. 5 is a side view of the seal element according to an alternative configuration thereof.

### BEST MODE FOR CARRYING OUT THE INVENTION

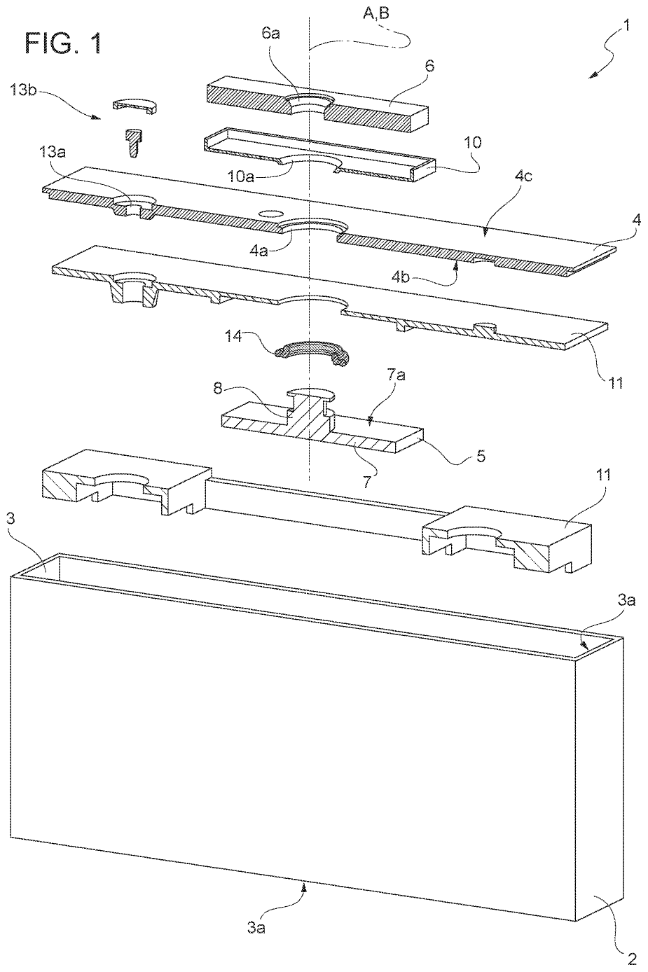

With reference to FIG. 1, number 1 indicates as a whole a lid assembly for a prismatic battery cell.

In particular, the battery cell is of the prismatic type and has a hollow prismatic casing 2 which internally defines an inner compartment 3 with an opening 3a to access inner compartment 3.

The battery cell further comprises electrodes (cathode and anode, not shown), which are housed in inner compartment 3 together with separator material (not shown) and an electrolytic solution (not shown).

The electrodes and the separator material are inserted into inner compartment 3 from opening 3a.

Accordingly, lid assembly 1 is configured to be coupled with casing 2 at opening 3a for fluid-tightly closing inner compartment 3, as required during the normal use of the battery cell.

Hence, the battery cell comprises casing 2, with the electrodes, the separator and the electrolytic solution, and lid assembly 1.

According to the embodiment shown, casing 2 has a parallelepiped shape. However, casing 2 could have any prismatic shape, such as cubic, triangular-based, etc.

In one embodiment, casing 2 could be cylindrical.

The present invention will refer to a prismatic battery cell, without however losing generality.

In particular, the present invention will refer to a battery cell for use in the automotive industry, for example in a battery module of a hybrid or full-electric vehicle, without however losing generality.

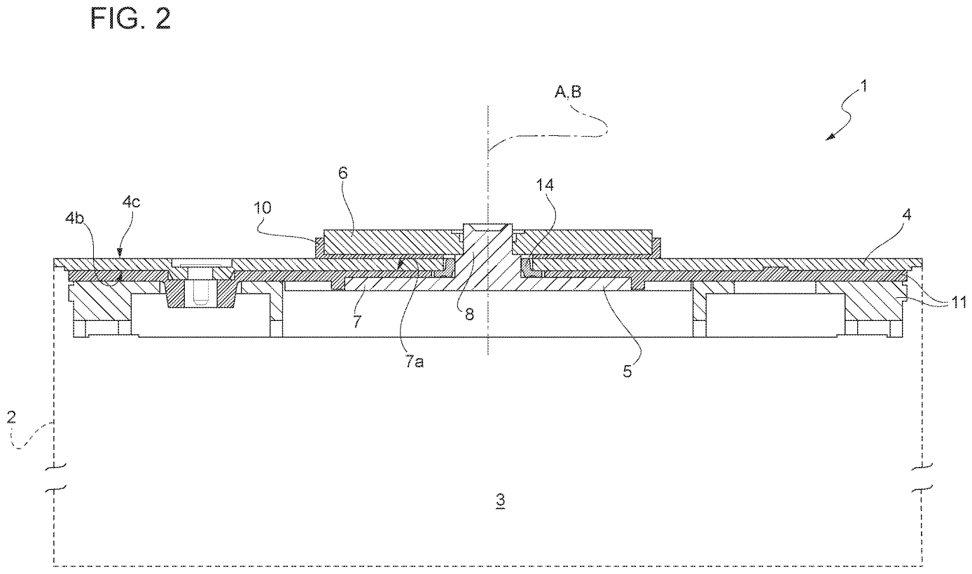

With reference to FIGS. 1 and 2, lid assembly 1 essentially comprises:
a base plate 4, made of metallic material, preferably aluminum, for closing opening 3a of inner compartment 3, namely arranged to match the shape of, and engage, opening 3a;
a current collector 5 electrically connectable to a respective electrode of the battery cell within inner compartment 3 for collecting electric energy therefrom and transferring it from inner compartment 3 outwards;
a terminal 6 electrically coupled with collector 5 for receiving the electric energy therefrom, and which is configured to receive a connector (not shown) of a consumer device (not shown) which is to be powered by the battery cell.

Collector 5 includes a plate body 7 for electric connection with the respective electrode and a pin 8 which has a substantially cylindrical shape and projects from plate body 7, preferably orthogonally.

Base plate 4 has a through hole 4a, an inner wall 4b configured to face inner compartment 3 (in assembled conditions, see FIG. 2), and an outer wall 4c opposite inner wall 4b and configured to face the outside environment.

Pin 8 engages through hole 4a so as to orthogonally protrude from outer wall 4c and so that a surface 7a of plate body 7 from which pin 8 projects faces inner wall 4b (FIG. 2).

Terminal 6 is mechanically coupled to pin 8, so as to establish said electric connection.

In detail, terminal 6 has a through hole 6a engaged by pin 8, up until terminal 6 rests on outer wall 4c, conveniently with the interposition of an electrically insulating gasket 10, so that terminal 6 and base plate 4 are electrically insulated from one another. Opportunely, also gasket 10 includes a trough hole 10a.

Pin 8 extends along an axis A and through holes 4a, 6a and 10a are expediently coaxial with pin 8.

Hence, terminal 6 faces outwards, ready to receive the aforementioned connector, and is electrically insulated from base plate 4 (by gasket 10), in order to avoid a current dispersion thereon or a short circuit.

Conveniently, lid assembly 1 further comprises:
stop frames 11 made of an electrically insulating material (such as rigid plastic), known per se and not described in detail;
a pour opening 13a obtained in base plate 4 through which the electrolytic solution is to be inserted; and
a cap 13b for closing pour opening 13a.

Lid assembly 1 further comprises a seal element 14 mechanically interposed between collector 5 and base plate 4 for electrically insulating collector 5 and base plate 4 from one another and for fluid-tightly sealing inner compartment 3 from the outside environment.

In detail, seal element 14 is configured to prevent a leakage of electrolytic solution outside of inner compartment 3 and/or an undesired entering of external impurities (dust, sand, dirt in general) within inner compartment 3.

Preferably, seal element 14 is made of an elastomeric material, such as EPDM rubber, FKM rubber, HNBR rubber, NBR rubber, or other similar materials.

FIG. 1 shows lid assembly 1 in exploded view, while FIG. 2 shows lid assembly 1 is assembled conditions, i.e. in use and with all the above components coupled to one another and to casing 2.

In FIG. 1, only one top opening 3a of casing 2 is shown.

However, casing 2 can have more than one opening 3a, for example top opening 3a and a bottom opening 3b (not visible in FIG. 1) opposite to opening 3a. Opening 3b is configured to be closed by a further lid assembly (not shown) substantially corresponding to lid assembly 1.

In particular, each lid assembly is provided for one electrode, the respective terminal 6 being connected to one of the cathode and the anode.

Alternatively, openings 3a, 3b could also define lateral openings of casing 2.

In another embodiment not shown, casing 2 has only a single opening. Accordingly, in this case lid assembly has a single base plate 4, but two terminals 6, two collectors 5 and two seal elements 14, one for each electrode.

Reference will be made in the following to seal element 14.

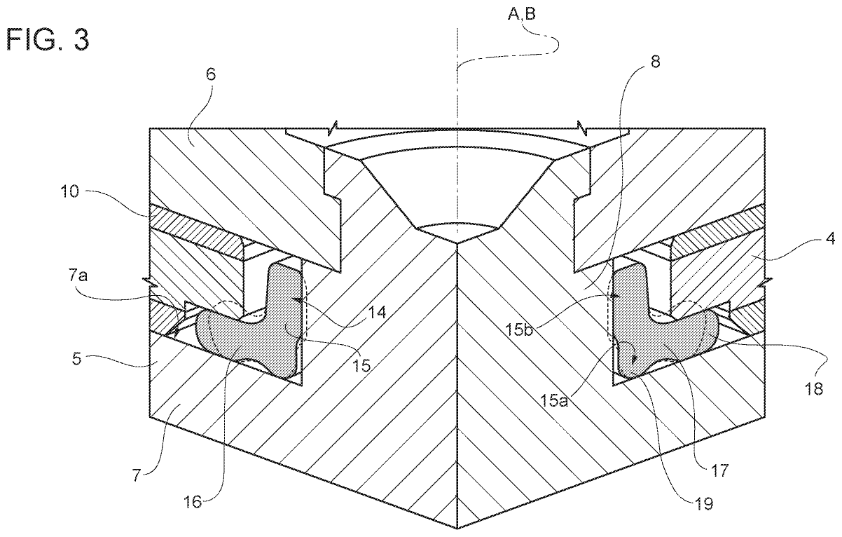

Seal element 14 has a central axis B, which in assembled conditions (as visible in FIGS. 2 and 3) is coaxial to axis A, and presents a substantially L-shaped semi-profile with respect to axis B.

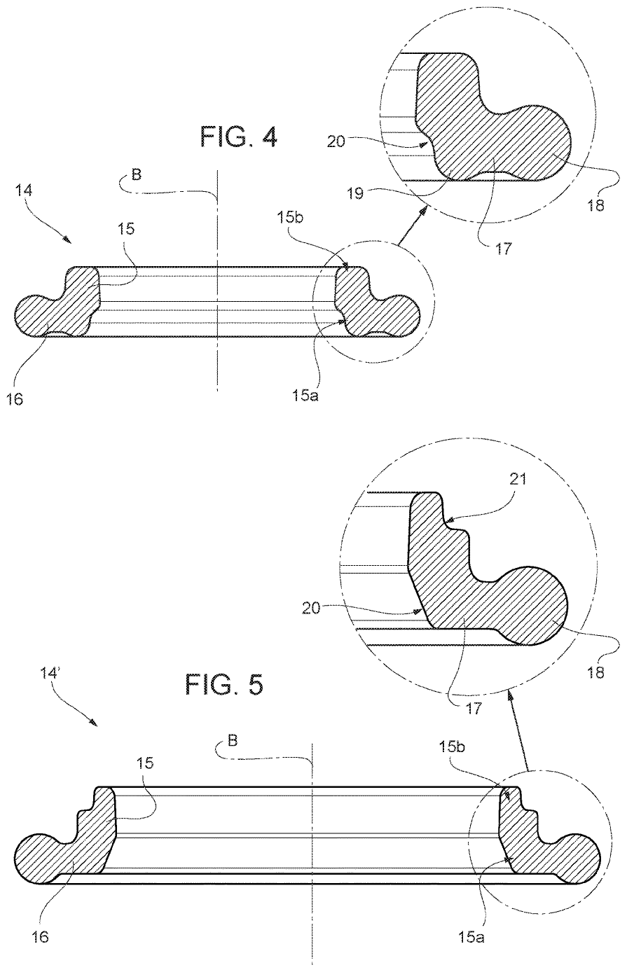

More specifically, a transversal cross-section of seal element 14 results in two L-shaped semi-profiles radially opposite to one another with respect to axis B. Seal element 14 comprises (FIGS. 3 and 4):
an axial collar 15 extending annularly about axis B and configured to electrically insulate collector 5 from base plate 4; and
a radial sealing portion 16 protruding from collar 15 in a cantilevered manner and configured to fluid-tightly seal inner compartment 3 from the outside environment.

Preferably, collar 15 and sealing portion 16 are made in one single piece without solution of continuity.

Conveniently, also sealing portion 16 performs the function of electrical insulator, as well as collar 15 performs the function of sealing element.

In particular, concerning the sealing function of seal element 14, sealing portion 16 is for the most part adapted to prevent a leakage of electrolytic solution outside of inner compartment 3 and collar 15 is for the most part adapted to prevent undesired entering of external impurities within inner compartment 3.

As visible in particular in FIG. 3, seal element 14 is to be fitted on collector 5 in such a way that pin 8 axially engages collar 15, so that collar 15 surrounds at least partially pin 8, and in such a way that sealing portion 16 (axially) rests on plate body 7.

In greater detail, sealing portion 16 (axially) rests on surface 7a of plate body 7 and is axially interposed and compressed, in use and in assembled conditions, between surface 7a and inner wall 4b, so that base plate 4 and collector 5 are coupled to one another via sealing portion 16 and without contacting (i.e. touching) one another.

Advantageously, sealing portion 16 includes a main body 17 and a bulge or bump 18 extending from main body 17 and defining a free end of sealing portion 16, bump 18 having an axial size greater than the axial size of main body 17.

In detail, sealing portion 16 extends radially outwards, with respect to axis B. Main body 17 extends annularly about axis B and is attached to collar 15. Bump 18 is attached to main body 17 and is arranged in a radially outermost position than main body 17 relative to axis B.

In greater detail, collar 15 has a first axial end 15a configured to face, in use and in assembled conditions of lid assembly 1, towards inner compartment 3 and a second axial end 15b opposite to first axial end 15a.

Sealing portion 16 is attached to first axial end 15a and protrudes radially therefrom in a cantilevered manner.

Preferably, bump 18 extends annularly in a continuous manner about axis B.

Conveniently, bump 18 has a substantially circular profile.

More specifically, bump 18 defines an o-ring shaped body of sealing portion 16.

It is specified that with the wording “profile” or “semi-profile” it is intended a cross section of the relative part or component.

Since bump 18 has an axial size greater than the axial size of main body 17, bump 18 is configured to be compressed, in use and in assembled conditions of lid assembly 1, between base plate 4 and collector 5, while leaving main body 17 substantially uncompressed.

The Applicant has observed that such a configuration ensures a more effective sealing of inner compartment 3, especially on the long run. As it is known, during use of the battery cell pressure could build up within inner compartment 3; in such a case, plate body 7 of collector 5 presses more and more towards base plate 4 and therefore onto sealing portion 16. The Applicant has observed, by means of an extensive experimental campaign, that thanks to the peculiar geometry of seal element 14, stresses concentrate on bump 18, while main body 17 remains substantially unstressed and undeformed, thus resulting in an increase of efficacy of sealing and in a decrease of the risks of electrical contact between collector 5 and base plate 4.

In addition, the presence of bump 18 according to the invention minimizes risk that base plate 4 and collector 5 come into axial contact.

Advantageously, seal element 14 comprises a second bulge or bump 19 arranged on collar 15 at the first axial end 15a thereof and in a position radially opposite to bump 18.

In particular, main body 17 is radially interposed between bump 18 and second bump 19, with respect to axis B.

More specifically, second bump 19 projects axially from first axial end 15a, extends annularly in a continuous manner about axis B, and defines a lobe of collar 15 with a curved profile.

In greater detail, second bump 19 defines a partially o-ring shaped body.

Preferably, second bump 19 has a radial size smaller than the radial size of bump 18, with respect to axis B.

Conveniently, second bump 19 has an axial size greater than the axial size of main body 17, with respect to axis B.

The Applicant has observed, by means of an extensive experimental campaign, that the presence of second bump 19 as described above increases stiffness of seal element 14, and in particular of sealing portion 16, which in turn results in a better distribution of the stresses caused by the axial compression of seal element 14. Such stresses are supported and absorbed for the major part by bump 18 and second bump 19, this latter acting as a support to counteract an excessive bending movement of sealing portion 16 and collar 15. Since bump 18 is the thickest part of sealing portion 16, this results in a reduction of wear of sealing portion 16.

Hence, thanks to second bump 19 the sealing action is even more effective. Also the electrical insulation benefits from the presence of second bump 19.

Moreover, the presence of bump 18 and second bump 19 as described above causes the collar 15 to bend radially outwards when seal element 14 is compressed between base plate 4 and collector 5 and/or is subjected to operational stresses.

In detail, second axial end 15b bend outwards, while first axial end 15a bend towards pin 8, abutting even more against this latter.

This increases the safety of lid assembly 1, since it ensures that pin 8 of collector 5 and base plate 4 are well-distanced from one another.

Moreover, centering of seal element 14 is further improved.

Ultimately, the peculiar geometry of seal element 14 according to the invention results in a more effective sealing and electrical insulation, with respect to the known seal elements (both o-ring shaped or L-shaped), as well as in an increased lifespan of the seal element 14 itself, due to the better management of the stresses.

Conveniently, collar 15 is fitted on pin 8 with radial interference.

The Applicant has noted that this results in a better centering of seal element 14 with respect to axis A and also increases even more the stiffness of seal element 14 over deformation, especially in combination with the presence of second bump 19.

In one embodiment, pin 8 is welded to plate body 7 by a weld seam (not shown).

In one embodiment, collector 5 has a rib (not shown) at the junction between pin 8 and plate body 7, which serves the function of strengthen collector 5.

Advantageously, seal element 14 further comprises a first annular groove 20 obtained on collar 15 at the first axial end 15a thereof.

Preferably, groove 20 extend continuously in an annular manner about axis B.

Gro 20 is configured to receive the aforementioned weld seam (also known as “overmetal”) or the aforementioned rib.

In this way, seal element 14 adapts to the geometry and/or the structural imperfections of lid assembly 1 (and especially of collector 5), thereby resulting in better fit and/or better fixation of seal element 14 to collector 5. Also, thanks to the fact that the geometry of seal element 14 takes into account the geometry of the collector 5, the stresses are reduced. This ultimately results in a better sealing and electrical insulating performance.

FIG. 5 shows seal element 14′ according to a different embodiment of the present invention.

Since seal element 14′ is similar to seal element 14, only the differences between these two will be described in the following, using the same reference numbers for equal or corresponding parts.

In particular, seal element 14′ further comprises a second annular groove 21 obtained on collar 15 at the second axial end 15b thereof.

Preferably, groove 21 extend continuously in an annular manner about axis B.

Groove 21 is configured to receive a corresponding (radial) rib (not shown) of base plate 4.

In this way, a better and more stable fixation of seal element 14′ with respect to base plate 4 can be obtained, whereby seal element 14′ will maintain its positioning even when subjected to internal stresses (e.g. due to pressure build ups) or external forces (e.g. vibrations).

Conveniently, seal element 14′ includes a first groove 20 of the aforementioned type.

In the embodiment shown, seal element 14′ is devoid of second bump 19, as the presence of groove 21 provides sufficient stiffness to seal element 14′. Hence, material can be saved in production.

The advantages of seal element 14, 14′ according to the present invention and of lid assembly 1 in which such seal element is implemented, will be clear from the foregoing description.

The peculiar geometry of seal element 14, 14′ according to the present invention results in a more effective sealing of inner environment 3 and in a more effective electrical insulation between base plate 4 and collector 5, as well as in an increased lifespan of the seal element 14, 14′ itself, due to the better management of the stresses.

In particular, the Applicant has observed, by means of an extended stress-strain analysis campaign, that there are no critical spots when the seal element 14, 14′ is subjected to forces which normally occur during use of lid assembly 1 in battery cells. More in particular, is has been noted how the most critical spot, which is the outer junction between sealing portion 16 and collar 15 remains relatively unstressed, while most of the stresses are absorbed and withstood by bump 18.

Furthermore, thanks to bump 18 as described above, and, if present, thanks also to second bump 19, seal element 14, 14′ provides for a better tolerance compensation, since bump 18 and, if present, second bump 19 allow a better and more robust compression, also considering the variation of operative conditions, such as temperature and pressure.

In addition, the Applicant has observed, by means of an extensive experimental campaign, that the peculiar geometry of seal element 14, 14′ resulted in a significative decrease in the axial stresses (due to compression between collector 5 and base plate 4).

Clearly, changes may be made to seal element 14, 14′ as described herein without, however, departing from the scope of protection as defined in the accompanying claims.

1. Lid assembly for a prismatic battery cell having a casing which internally defines an inner compartment and at least one opening for accessing the inner compartment, the lid assembly comprising:
a base plate for closing the opening of the inner compartment;
at least one current collector electrically connectable to a respective electrode of the battery cell within the inner compartment, for collecting electric energy and transferring it from the inner compartment outwards;
at least one terminal electrically coupled with the current collector for receiving the electric energy therefrom; and
a seal element mechanically interposed between the current collector and the base plate for electrically insulating the current collector and the base plate from one another and for fluid-tightly sealing the inner compartment from an outside environment;
the seal element having a central axis, presenting a substantially L-shaped semi-profile with respect to the central axis, and comprising:
an axial collar extending annularly about the central axis and configured to electrically insulate the current collector from the base plate, wherein the collar has a first axial end configured to face, in use and in assembled conditions, towards said inner compartment and a second axial end opposite to the first axial end; and
a radial sealing portion configured to fluid-tightly seal the inner compartment, wherein the sealing portion is attached to the first axial end and protrudes radially therefrom in a cantilevered manner;
the sealing portion including a main body and a bulge or bump extending from the main body and defining a free end of the sealing portion, the bulge or bump having an axial size greater than the axial size of the main body;
wherein:
the seal element comprises a first annular groove obtained on the collar at the first axial end thereof, said first groove being configured to receive a weld seam of said current collector or a rib of said current collector; and/or
wherein the seal element comprises a second annular groove obtained on the collar at the second axial end thereof, said second groove being configured to receive a corresponding rib of said base plate.

2. Lid assembly as claimed in claim 1, wherein the sealing portion extends radially outwards, with respect to the central axis; wherein the main body extends annularly about the central axis and is attached to the collar; and wherein the bulge or bump is attached to the main body and is arranged in a radially outermost position than the main body, relative to the central axis

3. Lid assembly as claimed in claim 1, wherein the seal element comprises a second bulge or bump arranged on the collar at the first axial end thereof and in a position radially opposite to said bulge or bump, the main body being radially interposed between the bulge or bump and the second bulge or bump.

4. Lid assembly as claimed in claim 3, wherein the second bulge or bump projects axially from said first axial end, extends annularly about the central axis, defines a lobe of the collar with a curved profile.

5. Lid assembly as claimed in claim 3, wherein the second bulge or bump has a radial size smaller than the radial size of said bulge or bump;
and/or wherein the second bulge or bump has an axial size greater than the axial size of said main body.

6. Lid assembly as claimed in claim 1, wherein the bulge or bump extends annularly about the central axis and has a substantially circular profile.

7. Lid assembly as claimed in claim 6, wherein the bulge or bump defines an o-ring shaped body of the sealing portion.

8. Lid assembly as claimed in claim 1, wherein the current collector includes a plate body for electric connection with the respective electrode and a pin extending along said central axis and projecting from the plate body;
wherein the seal element is fitted on the current collector in such a way that the pin axially engages the collar, so that the collar surrounds at least partially the pin, and in such a way that the sealing portion rests on the plate body.

9. Lid assembly as claimed in claim 8, wherein the collar is fitted on the pin with radial interference.

10. Lid assembly as claimed in claim 8, wherein the base plate has a through hole,
wherein the pin engages the through hole and a surface of the plate body from which the pin projects faces an inner wall of the base plate configured to face the inner compartment;
and wherein the sealing portion of the seal element rests on said surface and is axially interposed and compressed between said surface and said inner wall, so that the base plate and the current collector are coupled to one another via the sealing portion and without contacting one another.

11. Lid assembly as claimed in claim 1, wherein:
the pin is welded to the plate body by a weld seam and said first groove is configured to receive said weld seam; or
the current collector has a rib and said rib is configured to engage said first groove.

12. Lid assembly as claimed in claim 1, wherein the base plate has a rib and said rib is configured to engage said second groove.
